(19) United States
(12) Patent Application Publication
(10) Pub. No.: US 2004/0258808 A1
(43) Pub. Date: Dec. 23, 2004

(54) Edible covering material provided with grip

(76) Inventor: Jeng Seek Choi, Inchon (KR)

Correspondence Address: PARK & SUTTON LLP, 3255 WILSHIRE BLVD, SUITE 1110, LOS ANGELES, CA, 90010, US

(21) Appl. No.: 10/845,323

(22) Filed: May 14, 2004

(30) Foreign Application Priority Data
Jun. 19, 2003 (KR) 20-2003-0019360

(51) Int. Cl. A23L 1/31

(52) U.S. Cl. 426/138

(57) ABSTRACT

Disclosed is an edible covering material provided with a grip, in which an obtained edible product is easily cooked and eaten by consumers, and is not easily damaged. The edible covering material (10) includes a storage unit (20) obtained by molding an edible dough, and provided with a storage space (S) including an opening (22) formed at one side thereof and support portions (26) formed thereon, and the grip (30) formed integrally with the other side of the storage unit (20) and made of the same material as that of the storage unit (20). Internal and external surfaces of the storage unit (20) are coated with a waterproof layer (24). The storage unit (20) and the grip (30) have strengthened structures, and is not easily damaged, thereby providing reliability to the consumers and allowing the content (P) in the edible covering material (10) to be eaten together by the consumers.

### CROSS REFERENCE RELATED TO THE INVENTION

The applicant claims and requests a foreign priority, through the Paris Convention for the Protection of Industry Property, based on a patent application filed in the Republic of Korea (South Korea) with the filing date of Jun. 19, 2003, with the application number 20-2003-0019360, by the applicant. (see the attached declaration)

### BACKGROUND OF THE INVENTION

1. Field of the Invention

The present invention relates to an edible covering material provided with a grip, and more particularly to an edible covering material for covering an edible content having an irregular shape, in which a grip has an improved structure, thus being easily treated and manufactured.

2. Description of the Related Art

Generally, covering materials for easy treatment of food are divided into edible covering materials and inedible covering materials according to whether or not the materials are edible. The inedible materials are made of paper or synthetic resin film, and are removed from edible products to expose the content contained therein. The edible materials are various shapes including an ice cream cone serving as a container for containing the ice cream.

The edible covering material, which serves as a container for storing an edible content and does not deteriorate the taste of an obtained edible product, has been steadily developed. The manufacture of the above edible covering material is completed by forming a waterproof layer by coating liquefied protein and edible powder on internal and external surfaces of the covering material having a designated internal volume made of a starch dough and hardening the coated liquefied protein and edible powder, by filling the inside of the covering material with an edible content having an irregular shape, by recoating liquefied protein and edible powder on the overall surface of the covering material containing the content, and by frying the obtained product. Particularly, in case that the inside of the covering material is filled with a content containing moisture, the waterproof layer prevents the covering material from being damaged or broken due to the moisture so as to maintain the shape and characteristics of the covering material and assists absorption of oil into the product when the product is fried so as to enhance the taste of the content.

As shown in FIG. 1, a conventional edible covering material comprises a main body 1 having a conical shape, and a grip 2 attached to a lower part of the main body 1. An edible support member 3 is installed in the lower part of the main body 1, and an edible support member 4 is installed on an outer surface of the grip 2 corresponding to the support member 3. The edible support member 3 and the edible support member 4 are connected by a connection member 5.

However, the above-described conventional edible covering material has several problems, as follows. First, the grip 2 cannot be firmly fixed to the lower part of the main body 1. Second, the main body 1 cannot maintain its shape, and is easily damaged or broken.

### SUMMARY OF THE INVENTION

Therefore, the present invention has been made in view of the above problems, and it is an object of the present invention to provide an edible covering material provided with a grip, having an improved structure, formed on a storage unit so that edible content contained in the storage unit is easily cooked and eaten by consumers.

It is another object of the present invention to provide an edible covering material provided with a grip formed on a storage unit having a strengthened structure, which is not easily broken or damaged so that edible content contained in the storage unit is easily stored and cooked.

In accordance with the present invention, the above and other objects can be accomplished by the provision of an edible covering material provided with a grip, in which a storage space for containing a content therein is formed, comprising: a storage unit obtained by molding an edible dough, and provided with the storage space including an opening formed at one side thereof; and the grip formed integrally with the other side of the storage unit, and made of the same material as that of the storage unit.

Preferably, internal and external surfaces of the storage unit may be coated with a waterproof layer including a liquefied protein and an edible powder.

Further, preferably, support portions may be formed on both side surfaces of the storage unit.

More preferably, the support portions may be formed in plural number along a longitudinal direction of the storage unit, have a convex structure, and be tapered such that the upper part of each of the support portions has a width narrower than that of the lower part of each of the support portions.

Since the grip is firmly fixed to the main body of the storage unit, an obtained edible product including the content in the storage unit is easily cooked and eaten by consumers and the main body of the storage unit is not easily broken.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a conventional edible covering material provided with a grip;

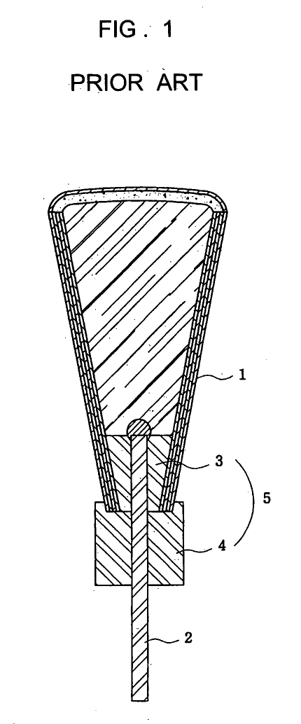

FIG. 2 is a perspective view of an edible covering material in accordance with the present invention;

FIG. 3 is a cross-sectional view of the edible covering material coated with a waterproof layer, which is taken along the line III-III of FIG. 2, in accordance with the present invention;

FIG. 4 is a cross-sectional view of the edible covering material coated with the waterproof layer and provided with a support unit, which is taken along the line IV-IV of FIG. 2, in accordance with the present invention; and

FIG. 5 is a cross-sectional view illustrating a processed state of the edible covering material provided with the grip containing a content in accordance with the present invention.

### DESCRIPTION OF THE PREFERRED EMBODIMENTS

Now, preferred embodiments of the present invention will be described in detail with reference to the annexed drawings.

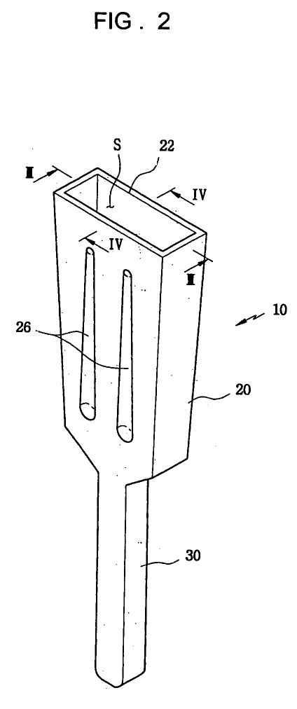

As shown in FIG. 2, an edible material 10 of the present invention includes a storage unit 20 having a storage space (S) for containing an edible content (P) having an irregular shape, and a grip 30 formed integrally with the storage unit 20. Thereby, the edible content (P), such as pizza toppings, is contained by the storage space (S), thereby being baked and fried and being eaten together with the covering material 10 by consumers.

The storage unit 20 is obtained by molding an edible dough, thus being edible and having the storage space (S) with a designated internal volume. The storage unit 20 has a rectangular shape, and is provided with an opening 22 formed through an upper part of the storage unit 20 so that the content (P) is put into and taken out of the storage space (S) having an approximately rectangular shape therethrough. As described above, the storage unit 20 is obtained by molding the edible dough made of starch.

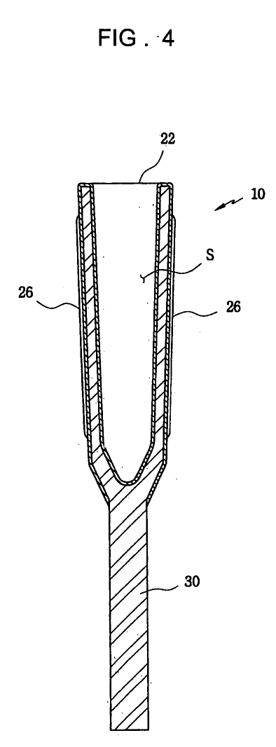

As shown in FIGS. 2 to 4, support portions 26, perpendicular to a longitudinal direction of the opening 22, are formed on both side surfaces of the storage unit 20. The support portions 26 serve to support the storage unit 20, thereby preventing the storage unit 20 from being broken or deformed. When the storage unit 20 is obtained by molding the dough, a plurality of the support portions 26 having a convex structure and a designated length are formed on the external surface of the storage unit 20 from the upper part to the lower part. Further, each of the support portions 26 is tapered such that the lower part has a width larger than that of the upper part. The above tapered structures of the support portions 26 are designed in consideration of the fact that the lower part of the storage unit 20 receives a torque much than the upper part of the storage unit 20 when the content (P) (particularly, the content containing moisture) is put into the storage unit 20.

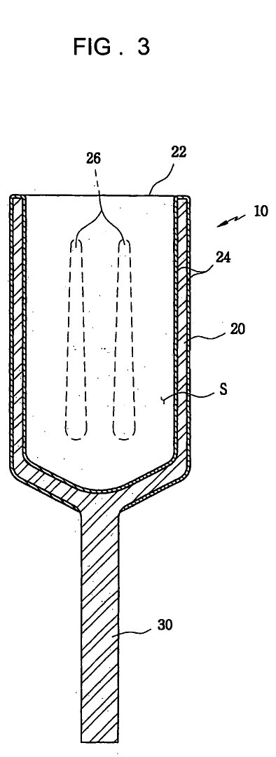

As shown in FIGS. 2 and 3, the grip 30, having a designated length, made of the same material as that of the storage unit 20 is formed integrally with the lower part of the storage unit 20. Since the grip 30 is made integrally with the storage unit when the storage unit 20 is obtained by molding the dough, the grip 30 is not detached from the storage unit 20 and is firmly fixed to the storage unit 20 when the edible covering material is baked together with the content (P) filling the storage unit (S) at a high temperature. Further, since the grip 30 is edible, the intake of the grip 30 along with the storage unit 20 and the content (P) thereof does not pose any risks to the health of a user, and stimulates user's curiosity or enjoyment.

As shown in FIG. 3, in order to strengthen the storage unit 20, a waterproof layer 24 is coated on internal and external surfaces of the storage unit 20. The waterproof layer 24 is made of liquefied protein and edible powder. The waterproof layer 24 serves to prevent the generation of problems, such as the deformation or breakage of the storage unit 20 caused by the moisture contained in the content (P). In order to form the waterproof layer 24, the liquefied protein, such as egg whites or a mixture of egg whites and yolks, is coated on the storage unit 20, and then the edible powder, such as bread crumb, is coated thereon so that the viscosity of the liquefied protein is regulated by the power to prevent the liquefied protein from flowing downward. Thereby, it is possible to strengthen the edible storage unit 20 and to prevent the storage unit 20 from being deformed by the moisture contained in the content (P). Further, the above liquefied protein and edible powder serve to allow the storage unit 20 containing the content (P) to have a nice taste when the storage unit 20 containing the content (P) is fried or baked.

Hereinafter, a manufacturing process and effects of the edible covering material provided with the grip in accordance with the present invention will be described in detail.

First, as shown in FIG. 2, the storage unit 20 having a rectangular shape and the grip 30 are integrally obtained by molding the dough made of starch using heat. When the storage unit 20 is obtained by molding, two support portions 26 are respectively formed on both external surfaces of the storage unit 20 in a longitudinal direction so as to firmly maintain the shape of the storage unit 20. Then, as shown in FIG. 3, in order to strengthen the storage unit 20, the waterproof layer 24 made of the liquefied protein and the edible powder is uniformly coated on the internal and external surfaces of the storage unit 20, and is then heated. The edible covering material provided with the grip in accordance with the present invention is completed by the above manufacturing process.

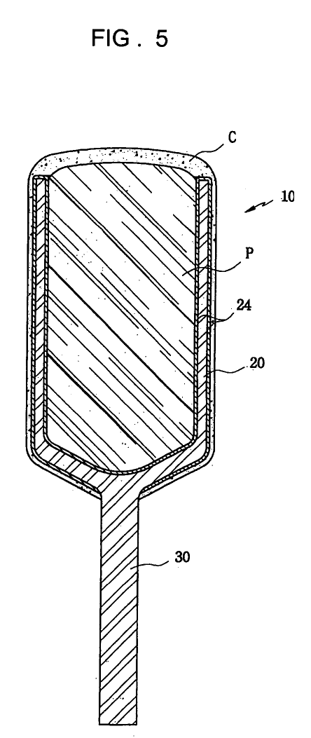

Now, a modified embodiment of the present invention will be described with reference to FIG. 5. In order to form the grip 30 integrally with the storage unit 20 and to strengthen the storage unit 20, the content. (P), such as pizza toppings, fully fills the storage space (S) of the edible covering material 10 coated with the waterproof layer 24, and an edible powder or a dough is coated on the exposed surface of the content (P) and the storage unit 20, thus forming a cover layer (C) on the exposed surface of the content (P) and the storage unit 20. After the cover layer (C) is formed, the edible covering material 10 is baked at a suitable temperature. Thereby, the manufacture of the edible covering material 10 is completed. Further, the manufactured edible covering material 10 is refrigerated and then post-treated (wrapped) so that an edible product provided with the edible covering material 10 is simply heated using a heater or a microwave oven. Then, the obtained edible covering material 10 is distributed to consumers.

As described above, since the storage unit 20 is strengthened and the grip 30 is formed integrally with the storage unit 20, the storage space (S) can be filled with various contents (P) and the grip 30 can be stably fixed to the storage unit 20, thus allowing an obtained edible product to be easily cooked and eaten by consumers.

As apparent from the above description, the present invention provides an edible covering material provided with a grip firmly fixed to a storage unit, thus allowing an obtained edible product including a content stored in the storage unit to be easily cooked and eaten by consumers. Further, the storage unit has a strengthened structure, and is not easily broken or damaged, thereby allowing the obtained edible product to be easily stored and cooked.

Accordingly, consumers can have reliability to the obtained product and eat the content together with the edible covering material, thus feeling the rich and nice taste of the content.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An edible covering material provided with a grip, in which a storage space for containing a content therein is formed, comprising:
a storage unit obtained by molding an edible dough, and provided with the storage space including an opening formed at one side thereof; and
the grip formed integrally with the other side of the storage unit, and made of the same material as that of the storage unit.

2. The edible covering material as set forth in claim 1,
wherein internal and external surfaces of the storage unit are coated with a waterproof layer including a liquefied protein and an edible powder.

3. The edible covering material as set forth in claim 1,
wherein support portions are formed on both side surfaces of the storage unit.

4. The edible covering material as set forth in claim 3,
wherein the support portions are formed in plural number along a longitudinal direction of the storage unit, have a convex structure, and are tapered such that the upper part of each of the support portions has a width narrower than that of the lower part of each of the support portions.
